(19) United States
(12) Patent Application Publication
(10) Pub. No.: US 2019/0287064 A1
(43) Pub. Date: Sep. 19, 2019

(54) DELIVERY SYSTEM

(71) Applicant: HONDA MOTOR CO., LTD., Tokyo (JP)

(72) Inventors: Naoko Imai, Wako-shi (JP); Atsuyuki Suzuki, Wako-shi (JP); Tomoko Shintani, Wako-shi (JP)

(21) Appl. No.: 16/282,500

(22) Filed: Feb. 22, 2019

(30) Foreign Application Priority Data
Mar. 16, 2018 (JP) 2018-049832

(51) Int. Cl. G06Q 10/08; B60R 25/24; H04W 4/029

(52) U.S. Cl. CPC G06Q 10/08355; G06Q 10/0833; H04W 4/029; B60R 25/24; G06Q 10/0832

(57) ABSTRACT

The delivery system includes an absence recognition unit which recognizes that a user of a vehicle becomes absent from a home, a vehicle position recognition unit which recognizes a position of the vehicle, a delivery request acceptance unit which accepts first delivery request information for the user using the home as a delivery destination, and a delivery destination change unit which transmits, when the delivery request acceptance unit accepts the first delivery request information and the absence recognition unit recognizes that the user becomes absent from the home at a scheduled delivery date and time to the home based on the first delivery request information, second delivery request information generated by changing the delivery destination in the first delivery request information from the home to the vehicle to a delay company system.

### INCORPORATION BY REFERENCE

The present application claims priority under 35 U.S.C. § 119 to Japanese Patent Application No. 2018-049832 filed on Mar. 16, 2018. The content of the application is incorporated herein by reference in its entirety.

### BACKGROUND OF THE INVENTION

### Field of the Invention

The present invention relates to a delivery system.

### Description of the Related Art

Conventionally, a delivery system adapted to deliver an article to be delivered to a receiving vehicle to enable the article to be delivered to be delivered if a recipient is absent has been proposed (see, e.g., Japanese Patent Laid-Open No. 2006-206225). In the delivery system described in Japanese Patent Laid-Open No. 2006-206225, authentication information for unlocking a trunk of the receiving vehicle is previously registered in a delivery information server.

A deliverer performs communication with the receiving vehicle using a communication device provided in a delivery vehicle and performs authentication based on authentication information, to unlock the trunk of the receiving vehicle. The deliverer accommodates the article to be delivered in the trunk of the receiving vehicle, to lock the trunk.

The delivery system described in Japanese Patent Laid-Open No. 2006-206225 enables a delivery to be completed by accommodating the article to be delivered in a vehicle parked at a delivery destination even if the recipient is absent. However, when the deliverer has reached the delivery destination, the vehicle may have been used so that no receiving vehicle has existed at the delivery destination depending on a delivery timing. In this case, the deliverer cannot complete the delivery. Accordingly, a redelivery needs to be performed. However, when the recipient is absent for a long period due to admission to a hospital, travel, or the like, a situation where the redelivery cannot be performed is continued. Therefore, the deliverer needs to take an action, for example, keep the article to be delivered for a long period until the redelivery can be performed or return the article to be delivered to a requester, resulting in inconveniently reduced delivery efficiency.

The present invention has been made in view of the above-described background, and is directed to providing a delivery system which inhibits delivery efficiency from being reduced due to absence of a recipient.

### SUMMARY OF THE INVENTION

A delivery system according to an aspect of the present invention includes an absence recognition unit which recognizes that a user of a vehicle becomes absent from a residence, a vehicle position recognition unit which recognizes a position of the vehicle, a delivery request acceptance unit which accepts first delivery request information for requesting to deliver an article to the user using the residence as a delivery destination, and a delivery destination change unit which transmits, when the delivery request acceptance unit accepts the first delivery request information and the absence recognition unit recognizes that the user becomes absent from the residence at a scheduled delivery date and time to the residence based on the first delivery request information, second delivery request information generated by changing the delivery destination in the first delivery request information from the residence to the vehicle the position of which is recognized by the vehicle position recognition unit to a delay company system.

According to the aspect of the present invention, when the absence recognition unit recognizes that the user becomes absent from the residence on the scheduled delivery date and time to the residence of the user of the vehicle based on the first delivery request information, the delivery destination change unit changes the delivery destination from the residence to the vehicle the position of which is recognized by the vehicle position recognition unit. As a result, even if the user is absent from the residence because the user is out using the vehicle so that no receiving vehicle exists in the residence, an article to be delivered can be delivered to the vehicle away from the residence. Therefore, delivery efficiency can be inhibited from being reduced due to absence of a recipient.

The delivery system may be configured such that the second delivery request information includes a virtual key for unlocking a door of the vehicle.

According to the configuration, when information about the virtual key is transmitted to a communication terminal of a deliverer from the delivery company system which has received the second delivery request information, the deliverer can unlock the door of the vehicle and accommodate the article to be delivered in a vehicle interior.

The delivery system may be configured such that the delivery destination change unit transmits, when the delivery request acceptance unit accepts the first delivery request information and the absence recognition unit recognizes that the user becomes absent from the residence at the scheduled delivery date and time to the residence based on the first delivery request information, delivery destination confirmation information for inquiring whether or not the delivery destination based on the first delivery request information is changed from the residence to the vehicle to a user terminal used by the user, and transmits, when the delay destination change unit receives from the user terminal delivery destination change instruction information instructing to change the delivery destination to the vehicle in response to the transmission of the delivery destination confirmation information, the second delivery request information to the delivery company system.

According to the configuration, when the delivery destination is changed from the residence of the user to the vehicle, the delivery destination change unit transmits the delivery destination confirmation information to the user terminal, to ask the user to confirm whether the delivery destination is changed. As a result, the delivery destination can be avoided being changed to the vehicle against a user's will.

The delivery system may be configured to further include a user position recognition unit which recognizes a position of the user, in which the delivery destination change unit transmits, when a distance between the position of the user recognized by the user position recognition unit and the position of the vehicle recognized by the vehicle position recognition unit is within a predetermined distance range, the delivery destination confirmation information to the user terminal.

According to the configuration, a situation where the article to be delivered is unconditionally delivered to the vehicle and the user cannot receive the article to be delivered if the distance between the user and the vehicle is short or the user is in the vehicle and may immediately move in the vehicle, or conversely if the distance between the user and the vehicle is long and the user may not use the vehicle for a while, for example, can be avoided.

The delivery system may be configured to further include a person-at-home recognition unit which recognizes whether or not a person at home is present in the residence, in which the delivery destination change unit transmits, when the person-at-home recognition unit recognizes that the person at home is present in the residence, the delivery destination confirmation information to the user terminal.

According to the configuration, the user can have, when a person at home such as a user's family member is present in the residence, the person at home receive the article to be delivered by transmitting from the user terminal delivery destination change instruction information instructing that the delivery destination remains the residence without being changed to the vehicle.

The delivery system may further include an article-to-be-delivered type recognition unit which recognizes a type of the article, in which the delivery destination change unit transmits, when the article-to-be-delivered type recognition unit recognizes that the article to be delivered is an article to be delivered of a predetermined type, the delivery destination confirmation information to the user terminal.

According to the configuration, the user can avoid, when the type of the article to be delivered is an article used in the residence, for example, a large-sized home electrical appliance, the article used in the residence being delivered to the vehicle by transmitting from the user terminal delivery destination change instruction information instructing that the delivery destination remains the residence without being changed to the user.

### BRIEF DESCRIPTION OF THE DRAWINGS

FIG. 1 is an explanatory diagram illustrating a delivery form of an article to a vehicle using a delivery system;

FIG. 2 is a configuration diagram of the delivery system;

FIG. 3 is an explanatory diagram of processing for registering use of a delivery service provided by the delivery system and processing for changing a delivery destination;

FIG. 4 is an explanatory diagram of user registration information; and

FIG. 5 is an explanatory diagram of user delivery information.

### DETAILED DESCRIPTION OF THE PREFERRED EMBODIMENTS

[1. Delivery Form Using Delivery System]

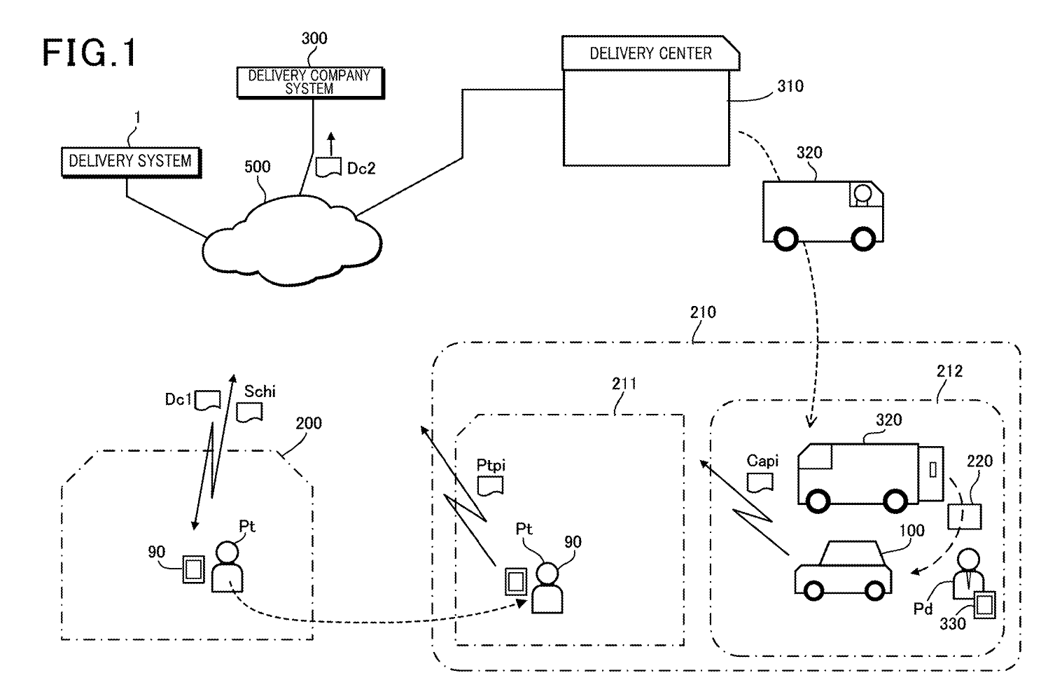

FIG. 1 illustrates a delivery form of an article to a vehicle using a delivery system in the present embodiment. Referring to FIG. 1, a delivery system 1 in the present embodiment performs processing for supporting a delivery to a home 200 or a vehicle 100 of a user Pt. Note that a location of the home 200 corresponds to a residence in the present invention.

The delivery system 1 is communicably connected to a user terminal 90 used by the user Pt, the vehicle 100 used by the user Pt, and a delivery company system 300 via a communication network 500. The delivery company system 300 is communicably connected to a delivery center 310 and a deliverer terminal 330 used by a deliverer Pd via the communication network 500. Communication connection among communication elements may be wired connection or wireless connection. Examples of the user terminal 90 and the deliverer terminal 330 include a smartphone, a mobile phone, and a tablet terminal.

FIG. 1 illustrates a situation where when the user Pt who has previously registered use of a delivery service provided by the delivery system 1 is admitted to a hospital 210, a delivery destination is changed from the home 200 to a parking lot 212 in the hospital 210. The delivery system 1 registers schedule book information Schi of the user Pt transmitted from the user terminal 90, and recognizes a schedule of the user Pt. The delivery system 1 receives position information of the user terminal 90 (user position information) Ptpi transmitted from the user terminal 90 and position information of the vehicle 100 (vehicle position information) Capi transmitted from the vehicle 100, and recognizes a position of the user Pt and a position of the vehicle 100.

The user Pt lives alone in the home 200, and operates the user terminal 90 to transmit to the delivery system 1 first delivery request information Dc1 for requesting to deliver an article to the home 200 before being admitted to the hospital 210. Then, the user Pt is admitted to a hospital ward 211 by moving to the hospital 210 in the vehicle 100 and parking the vehicle 100 in the parking lot 212 in the hospital 210.

In this case, even if an article to be delivered is delivered to the home 200, the article to be delivered can neither be delivered to the user Pt nor be accommodated in the vehicle 100 because the user Pt is absent from the home 200 and the vehicle 100 is also away from the home 200. The delivery system 1 refers to schedule book information of the user Pt, to recognize that the user Pt is admitted to the hospital 210 and change the delivery destination to the vehicle 100 of the user Pt parked in the parking lot 212 in the hospital 210.

The delivery system 1 changes the delivery destination to the vehicle 100, and transmits to the delivery company system 300 second delivery request information Dc2 generated by changing the delivery destination to a parking position of the vehicle 100. The delivery company system 300, which has received the second delivery request information Dc2, transmits delivery instruction information based on the second delivery request information Dc2 to the delivery center 310. A delivery is prepared in the delivery center 310 according to the delivery instruction information, and is performed to the vehicle 100 by the delivery vehicle 320. Delivery route information for designating a delivery destination, an article to be delivered, a delivery route, and the like is transmitted from the delivery center 310 to the deliverer terminal 330.

The deliverer Pd operates the deliverer terminal 330, to perform short-distance wireless communication based on a communication standard such as BLE (Bluetooth (registered trademark) Low Energy) and NFC (Near Field Communication) between the vehicle 100 and the deliverer terminal 330, to unlock a door of the vehicle 100 using a virtual key and accommodate an article (an article to be delivered) 220 in a vehicle interior of the vehicle 100. The virtual key is transmitted to the deliverer terminal 330 from the delivery system 1 via the delivery company system 300. The deliverer Pd locks the door of the vehicle 100 using the virtual key, to complete a delivery to the vehicle 100. The user Pt himself/herself can go for the article 220 accommodated in the vehicle interior of the vehicle 100, or the user Pt can ask an attendant user's family member, for example, to fetch the article 220.

[2. Configuration of Delivery System]

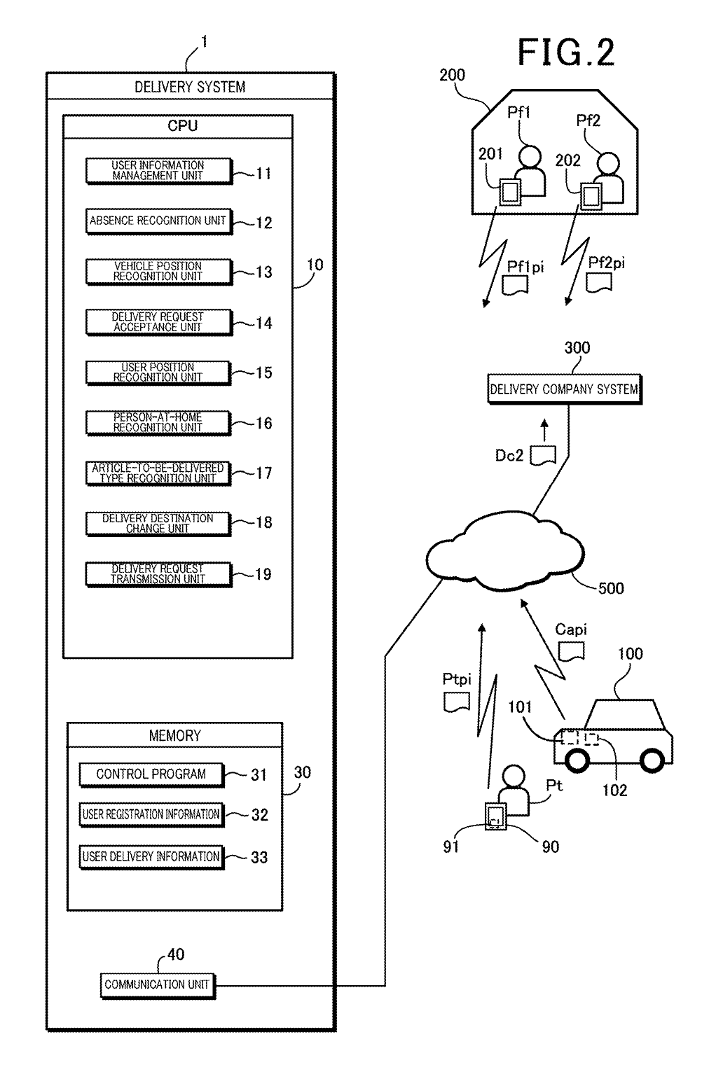

FIG. 2 is a configuration diagram of the delivery system 1. Referring to FIG. 2, the delivery system 1 is a computer system including a CPU (central processing unit) 10, a memory 30, a communication unit 40, various types of interface circuits (not illustrated), and the like. The CPU 10 functions as a user information management unit 11, an absence recognition unit 12, a vehicle position recognition unit 13, a delivery request acceptance unit 14, a user position recognition unit 15, a person-at-home recognition unit 16, an article-to-be-delivered type recognition unit 17, a delivery destination change unit 18, and a delivery request transmission unit 19 by reading and executing a control program 31 in the delivery system 1 stored in the memory 30.

The memory 30 stores user registration information 32 in which information about a user who has registered use of the delivery service using the delivery system 1 is recorded, user delivery information 33 in which scheduled delivery information for the user is recorded, and the like, in addition to the control program 31.

In an example illustrated in FIG. 1, the user information management unit 11 receives information about the user Pt (a name, information about the vehicle 100 to be used, a virtual key of the vehicle 100, etc.) transmitted from the user terminal 90 in response to a registration operation performed by the user Pt, to issue a user ID (identification) as identification information of the user Pt. Information about the virtual key is stored in a vehicle control device in the vehicle 100. Accordingly, authentication is performed using the virtual key so that the door of the vehicle 100 can be unlocked and locked.

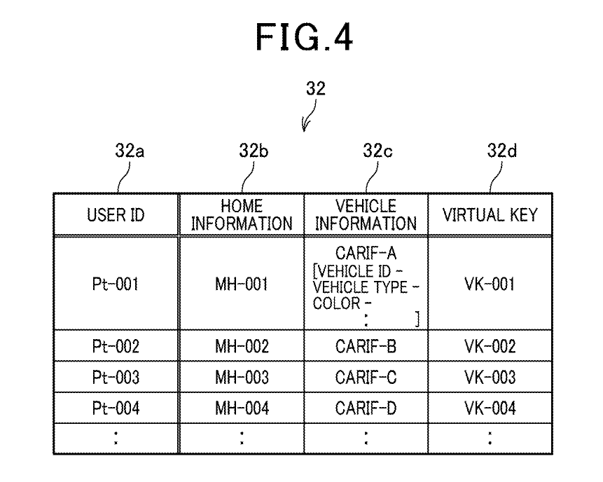

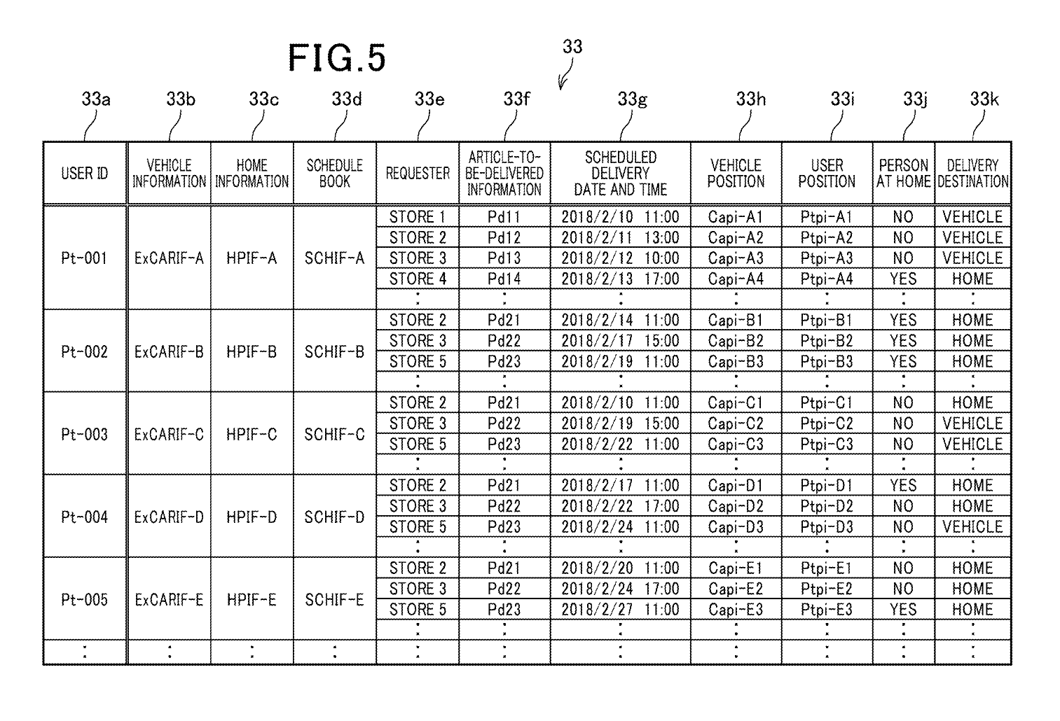

As illustrated in FIG. 4, home information 32b, vehicle information 32c, and a virtual key 32d of each of users are recorded in the user registration information 32 to correspond to a user ID 32a of the user. As illustrated in FIG. 5, vehicle information 33b, home information 33c, a schedule book 33d, a requester 33e, article-to-be-delivered information 33f, a scheduled delivery date and time 33g, a vehicle position 33h, a user position 33i, a person at home 33j, and a delivery destination 33k are recorded in the user delivery information 33 to correspond to a user ID of each of users.

Referring to FIG. 1, the vehicle position information Capi transmitted to the delivery system 1 from the vehicle 100 includes information about a position (a latitude and a longitude) of the vehicle 100 detected by a navigation device 101 in the vehicle 100. The user position information Ptpi transmitted to the delivery system 1 from the user terminal 90 used by the user Pt includes information about a position (a latitude and a longitude) of the user Pt detected by a GPS (global positioning system) unit 91 provided in the user terminal 90.

The absence recognition unit 12 refers to the schedule book 33d in the user delivery information 33, to recognize a date and time at which the user Pt becomes absent from the home 200 due to the admission to the hospital 210, described above, travel, and homecoming visit, etc. The vehicle position recognition unit 13 receives the vehicle position information Capi transmitted from the vehicle 100, and recognizes a position of the vehicle 100 based on the vehicle position information Capi. The user information management unit 11 records the position of the vehicle 100 recognized by the vehicle position recognition unit 13 in the vehicle position 33h in the user delivery information 33.

The delivery request acceptance unit 14 receives the first delivery request information Dc1 (see FIG. 1) transmitted in response to an operation of the user terminal 90 or a store terminal provided in a store, for example, to accept a request to deliver the article 220 to the user Pt. The user position recognition unit 15 receives the user position information Ptpi transmitted from the user terminal 90, and recognizes the position of the user Pt based on the user position information Ptpi. The user information management unit 11 records the position of the user Pt recognized by the user position recognition unit 15 in the user position 33i in the user delivery information 33.

The person-at-home recognition unit 16 determines, when it recognizes that the user Pt lives with roommates Pf1 and Pf2 such as user's family members from the home information 33c in the user delivery information 33, whether or not the roommate Pf1 or the roommate Pf2 is present in the home 200. That is, the person-at-home recognition unit 16 recognizes respective positions of the roommates Pf1 and Pf2 from position information Pf1pi transmitted from a terminal 201 used by the roommate Pf1 and position information Pf2pi transmitted from a terminal 202 used by the roommate Pf2.

The person-at-home recognition unit 16 determines, when the position of the roommate Pf1 substantially matches a position of the home 200 recorded in the home information 33c in the user delivery information 33, that the roommate Pf1 is present in the home 200. The same applies to the roommate Pf2. The user information management unit 11 records presence or absence of a person at home recognized by the person-at-home recognition unit 16 in the person at home 33j in the user delivery information 33.

The article-to-be-delivered type recognition unit 17 refers to the article-to-be-delivered information 33f in the user delivery information 33, to recognize the type of an article to be delivered. The type of the article to be delivered include the type of article a delivery to the vehicle 100 of which can be conceivably inappropriate, for example, food required to be refrigerated or frozen or an article assumed to be used at home such as a large-sized home electrical appliance or furniture.

The delivery destination change unit 18 determines, based on the schedule book 33d, the scheduled delivery date 33g of each article to be delivered, information about presence or absence of the person at home 33j, which are recorded in the user delivery information 33, whether or not the user Pt is present in the home 200. When the user Pt is absent, a delivery destination is changed from the home 200 to the vehicle 100 under a predetermined condition. The user information management unit 11 changes, when the delivery destination change unit 18 changes the delivery destination, a record of the delivery destination 33k in the user delivery information 33.

In an example illustrated in FIG. 5, for example, the delivery destination 33k is changed to a vehicle because a user assigned a user ID Pt-001 is absent from home and there is no person at home from Feb. 10 to Feb. 12, 2018 of the scheduled delivery date and time 33g from the schedule book 33d.

The delivery request transmission unit 19 refers to the user delivery information 33, to transmit to the delivery company system 300 the second delivery request information Dc2 indicating that the home 200 or the vehicle 100 of the user Pt is designated as a delivery destination for each article to be delivered. As a result, the article 220 is delivered to the home 200 or the vehicle 100 of the user Pt.

[3. Processing from User Registration to Delivery Instruction]

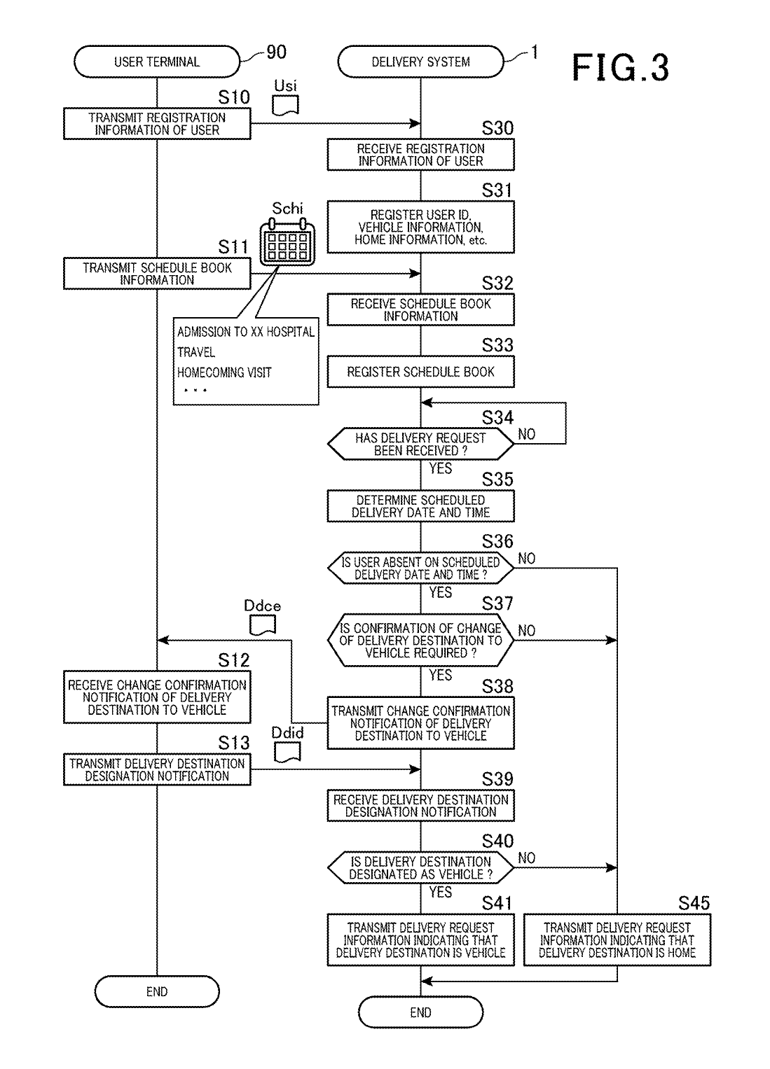

A series of processing performed by the delivery system 1 and the user terminal 90 in a process of delivering the article (article to be delivered) 220 to the vehicle 100 of the user Pt illustrated in FIG. 1 will be described below according to a flowchart illustrated in FIG. 3.

The user Pt browses a web page provided by the delivery system 1 using the user terminal 90 and inputs information required for registration on a registration application screen to use the delivery service provided by the delivery system 1. The user terminal 90 transmits registration information Usi inputted by the user Pt to the delivery system 1 in step S10 illustrated in FIG. 3. The registration information Usi includes a user ID issued by the delivery system 1, home information, information about the vehicle 100 (a vehicle ID for communication, a vehicle type, a color, etc.) used by the user Pt, a virtual key of the vehicle 100, and the like.

The home information includes a position (a latitude, a longitude, or an address) of the home 200, presence or absence of a roommate, and the like. The vehicle ID for communication includes identification information (a BLE authentication code, etc.) for performing short-distance communication with the communication unit 102 in the vehicle 100 and identification information (an IP address, etc.) for performing communication with the vehicle 100 via the communication network 500. In step S30, the delivery system 1 receives the registration information Usi of the user Pt. In subsequent step S31, the user information management unit 11 in the delivery system 1 registers the user ID, the home information, the vehicle information, and the virtual key acquired from the registration information Usi in the user registration information 32.

The user Pt performs an operation for registering a schedule book app used at the user terminal 90 in the delivery system 1. In step S11, the user terminal 90 transmits schedule book information Schi to the delivery system 1 in response to the operation. The user Pt inputs his/her own schedule in a schedule book, as needed, and the schedule book app transmits, when the schedule book information Schi is changed by adding a schedule to the schedule book or changing a schedule in the scheduled book, the changed schedule book information Schi to the delivery system 1.

The user information management unit 11 in the delivery system 1 receives the schedule book information Schi in step S32, and then registers the schedule book of the user Pt represented by the schedule book information Schi in the user delivery information 33 in subsequent step S33. Then, the user information management unit 11 updates the schedule book registered in the user delivery information 33 every time it receives the schedule book information Schi obtained by adding or correcting the schedule from the user terminal 90.

Subsequent step S34 is processing performed by the delivery request acceptance unit 14. When the delivery request acceptance unit 14 receives delivery request information transmitted from the user terminal 90, a store terminal, or the like, the processing proceeds to step S35. In step S35, the user information management unit 11 determines a scheduled delivery date and time of the article 220 based on a delivery destination, article-to-be-delivered information, a preferred delivery date, a scheduled delivery date and time of another article to be delivered, and the like designated based on the delivery request information. The user information management unit 11 registers the article-to-be-delivered information and the scheduled delivery date and time of the article 220 in the user delivery information 33.

Note that the scheduled delivery date and time may be determined by the delivery company system 300. In this case, the delivery company system 300 determines a scheduled delivery date and time of each of articles to be delivered in consideration of a delivery route or the like based on the second delivery request information Dc2 (see FIG. 1) transmitted to the delivery company system 300 from the delivery system 1. The delivery company system 300 is configured to transmit information about the scheduled delivery date and time of the article to be delivered to the delivery system 1.

Subsequent steps S36 to S39 are each processing performed by the delivery destination change unit 18. In step S36, the delivery destination change unit 18 refers to the schedule book of the user Pt registered in the user delivery information 33, to determine whether or not the user Pt becomes absent from the home 200 at the scheduled delivery date and time of the article 220.

If the delivery destination change unit 18 determines that the user Pt becomes absent from the home 200 at the scheduled delivery date and time of the article 220, the processing proceeds to step S37. If the delivery destination change unit 18 determines that the user Pt is present in the home 200, the processing proceeds to step S45.

In step S37, the delivery destination change unit 18 determines, when it is assumed that the user Pt becomes absent from the home 200 on the scheduled delivery date, whether or not the user Pt needs to confirm whether or not the delivery destination is changed from the home 200 to the vehicle 100. In the present embodiment, when at least any one of first to fifth conditions, described below, holds, the delivery destination change unit 18 does not unconditionally change the delivery destination from the home 200 to the vehicle 100 but determines that the user Pt needs to confirm whether or not the delivery destination is changed from the home 200 to the vehicle 100.

First condition . . . A distance between the position of the vehicle 100 recognized by the vehicle position recognition unit 13 and the position of the user Pt recognized by the user position recognition unit 15 is a first predetermined distance (e.g., several meters) or less (corresponding to a predetermined distance range in the present invention).

Second condition . . . A distance between the position of the vehicle 100 recognized by the vehicle position recognition unit 13 and the position of the user Pt recognized by the user position recognition unit 15 is a second predetermined distance (e.g., several kilometers) or more (corresponding to a predetermined distance range in the present invention).

Third condition . . . The type of the article 220 is food required to be stored frozen or refrigerated (corresponding to an article of a predetermined type in the present invention).

Fourth condition . . . The type of the article 220 is a product assumed to be used in the home 200 (corresponding to an article of a predetermined type in the present invention), like a large-sized home electrical appliance.

Fifth condition . . . A roommate is present in the home 200.

When the first condition holds, it is assumed that the user Pt is in the vehicle 100 or immediately gets into the vehicle 100 and moves in the vehicle 100. Therefore, when the delivery vehicle 320 reaches the delivery destination, the vehicle 100 has already moved to another place so that the article 220 may be undeliverable.

When the second condition holds, it is assumed that the user Pt is significantly far away from the vehicle 100 and does not return to the vehicle 100 for a while. Therefore, it is considered that there are few merits of hurrying to deliver the article 220 to the vehicle 100.

When the third condition holds, even if the food required to be stored frozen or refrigerated is delivered to the vehicle 100, the food cannot be stored in the vehicle 100. Accordingly, if the user Pt is late in fetching the food to the vehicle 100, the food may be deteriorated.

When the fourth condition holds, even if the large-sized home electrical appliance is delivered to the vehicle 100, the home electrical appliance is not used until the user Pt returns to the home 200. Accordingly, it is considered that there are few merits of hurrying to deliver the home electrical appliance to the vehicle 100.

When the fifth condition holds, if the article 220 is an article (a cosmetic, etc.) personally used by the user Pt and is immediately required, for example, the article cannot be used by the user Pt even if received by the roommate in the home 200. Thus, it is considered that a delivery of the article 220 to the vehicle 100 meets a need of the user Pt.

In step S38, the delivery destination change unit 18 transmits to the user terminal 90 a change confirmation notification Ddce (corresponding to delivery destination confirmation information in the present invention) for inquiring whether or not the delivery destination is changed from the home 200 to the vehicle 100. The change confirmation notification Ddce has a content in which the condition, which holds among the above-described first to fifth conditions, is presented to ask the user Pt for confirmation as to whether or not the delivery destination is changed from the home 200 to the vehicle 100. The change confirmation notification Ddce may include the type of the article 220. When the change confirmation notification Ddce includes the type of the article 220, the user Pt can determine whether or not the delivery destination of the article 220 is to be changed in consideration of the type of the article 220.

In step S12, the user Pt performs an operation for confirming the content of the change confirmation notification Ddce and designating the delivery destination using the user terminal 90. In step S13, the user terminal 90 transmits to the delivery system 1 delivery destination change instruction information Ddid for designating the delivery destination in response to the operation.

The delivery destination change unit 18 receives the delivery destination change instruction information Ddid in step S39, and then determines whether or not the delivery destination is designated as the vehicle 100 in subsequent step S40. The processing proceeds to step S41 when the delivery destination change unit 18 determines that the delivery destination is designated as the vehicle 100, and proceeds to step S45 when the delay destination change unit 18 determines that the delivery destination is designated as the home 200.

In step S41, the delivery request transmission unit 19 in the delivery system 1 transmits to the delivery company system 300 delivery request information indicating that the delivery destination has been changed from the home 200 to the vehicle 100. As a result, the article 220 is delivered to the vehicle 100 of the user Pt by the delivery vehicle 320, as illustrated in FIG. 1. In step S45, the delivery request transmission unit 19 transmits to the delivery company system 300 delivery request information indicating that the delivery destination is unchanged from the home 200. As a result, the article 220 is delivered to the home 200 of the user Pt.

[4. Another Embodiment]

Although short-distance communication is performed between the vehicle 100 and the deliverer terminal 330 to unlock the door of the vehicle 100 using the virtual key in the above-described embodiment, the virtual key need not be prepared if a physical key of the vehicle 100 is lent to a delivery company.

Although processing for asking the user Pt to confirm whether or not the delivery destination is changed from the home 200 to the vehicle 100 is performed in step S37 illustrated in FIG. 3 in the above-described embodiment, the processing may not be performed. Not all of the first condition to the fifth condition but any one, or any two or more of the conditions may be determined.

Although the second delivery request information Dc2 is transmitted to the delivery company system 300 from the delivery system 1 in the above-described embodiment, respective functions of a delivery company system 300 and a delivery center 310 may be incorporated into a deliverer terminal 330 to transmit second delivery request information Dc2 to the deliverer terminal 330 from a delivery system 1. In this case, the deliverer terminal 330 corresponds to a deliver company system in the present invention.

If a delivery locker in which food required to be refrigerated or frozen can be stored exists in the vicinity of a parking position of a vehicle 100, delivery request information, including information about the delivery locker (an existence place, a use method, etc.), may be transmitted to the delivery company system 300 from the delivery system 1. According to the configuration, even if an article to be delivered is food required to be refrigerated or frozen, for example, a delivery can be performed by transmitting a notification instructing that the article to be delivered is accommodated in the delivery locker is transmitted from the delivery company system 300 to the deliverer terminal 330.

Note that FIGS. 2 and 4 are schematic views illustrating a functional configuration of the delivery system 1 and the vehicle 100 while sectionalizing the functional configuration depending on a main processing content to facilitate understanding of the present invention. The delivery system 1 and the vehicle 100 may be configured by another sectionalization. Processing of each of components may be performed by one hardware unit, or may be performed by a plurality of hardware units. Processing of each of the components may be performed by one program, or may be performed by a plurality of programs.

### REFERENCE SIGNS LIST

1 . . . Delivery system, 10 . . . CPU, 11 . . . User information management unit, 12 . . . Absence recognition unit, 13 . . . vehicle position recognition unit, 14 . . . Delivery request acceptance unit, 15 . . . User position recognition unit, 16 . . . Person-at-home recognition unit, 17 . . . Article-to-be-delivered type recognition unit, 18 . . . Delivery destination change unit, 19 . . . Delivery request transmission unit, 30 . . . Memory, 31 . . . Control program, 32 . . . User registration information, 33 . . . User delivery information, 40 . . . Communication unit, 90 . . . User terminal, 100 . . . Vehicle, 210 . . . Hospital, 211 . . . Hospital ward, 212 . . . Parking lot, 220 . . . Article (article to be delivered), 300 . . . Delivery company system, and 310 . . . Delivery center.

What is claimed is:

1. A delivery system comprising:
an absence recognition unit which recognizes that a user of a vehicle becomes absent from a residence;
a vehicle position recognition unit which recognizes a position of the vehicle;
a delivery request acceptance unit which accepts first delivery request information for requesting to deliver an article to the user using the residence as a delivery destination; and
a delivery destination change unit which transmits, when the delivery request acceptance unit accepts the first delivery request information and the absence recognition unit recognizes that the user becomes absent from the residence at a scheduled delivery date and time to the residence based on the first delivery request information, second delivery request information generated by changing the delivery destination in the first delivery request information from the residence to the vehicle the position of which is recognized by the vehicle position recognition unit to a delivery company system.

2. The delivery system according to claim 1, wherein the second delivery request information includes a virtual key for unlocking a door of the vehicle.

3. The delivery system according to claim 1, wherein the delivery destination change unit transmits, when the delivery request acceptance unit accepts the first delivery request information and the absence recognition unit recognizes that the user becomes absent from the residence on the scheduled delivery date and time to the residence based on the first delivery request information, delivery destination confirmation information for inquiring whether or not the delivery destination based on the first delivery request information is changed from the residence to the vehicle to a user terminal used by the user, and transmits, when the delivery destination change unit receives from the user terminal delivery destination change instruction information for instructing to change the delivery destination to the vehicle in response to the transmission of the delivery destination confirmation information, the second delivery request information to the delivery company system.

4. The delivery system according to claim 3, further comprising
a user position recognition unit which recognizes a position of the user;
wherein the delivery destination change unit transmits, when a distance between the position of the user recognized by the user position recognition unit and the position of the vehicle recognized by the vehicle position recognition unit is within a predetermined distance range, the delivery destination confirmation information to the user terminal.

5. The delivery system according to claim 3, further comprising
a person-at-home recognition unit which recognizes whether or not a person at home is present in the residence,
wherein the delivery destination change unit transmits, when the person-at-home recognition unit recognizes that the person at home is present in the residence, the delivery destination confirmation information to the user terminal.

6. The delivery system according to claim 3, further comprising
an article-to-be-delivered type recognition unit which recognizes a type of the article,
wherein the delivery destination change unit transmits, when the article-to-be-delivered type recognition unit recognizes that the article to be delivered is an article to be delivered of a predetermined type, the delivery destination confirmation information to the user terminal.
